(19) United States
(12) Patent Application Publication
(10) Pub. No.: US 2021/0129195 A1
(43) Pub. Date: May 6, 2021

(54) METHOD OF IDENTIFYING AND REMOVING AGGREGATE

(71) Applicant: Bell Textron Inc., Fort Worth, TX (US)

(72) Inventors: Michael Scott Lee LARSON, Florence, AZ (US); Joseph VO, Keller, TX (US)

(73) Assignee: Bell Textron Inc., Fort Worth, TX (US)

(21) Appl. No.: 16/671,868

(22) Filed: Nov. 1, 2019

(51) Int. Cl. B08B 7/02; G01N 21/64

(52) U.S. Cl. CPC B08B 7/028; G01N 21/64

(57) ABSTRACT

An aggregate-removal method includes placing a metallic article in a tank of fluid, a piece of aggregate being lodged in a feature of the metallic article, and treating the metallic article with sound waves to dislodge the lodged aggregate from the metallic article. An aggregate-identification method includes applying a fluorescent penetrant solution to a metallic article, exposing the metallic article to UV light, and identifying fluorescing aggregate lodged in a feature of the metallic article.

### BACKGROUND

This section provides background information to facilitate a better understanding of the various aspects of the disclosure. It should be understood that the statements in this section of this document are to be read in this light, and not as admissions of prior art.

Surfaces of metallic articles are often polished to improve one or more of mechanical performance, wear characteristics, and appearance. Polishing of metallic articles is often done using a mechanically abrasive process such as machining or grinding. Some metallic articles can be difficult to polish using machining and grinding processes. For example, metallic articles with complex surfaces can be challenging to polish via machining or grinding. In these cases, chemical processes can be used to provide surface finishing.

### SUMMARY

An aggregate-removal method includes placing a metallic article in a tank of fluid, a piece of aggregate being lodged in a feature of the metallic article, and treating the metallic article with sound waves to dislodge the lodged aggregate from the metallic article.

An aggregate-identification method includes applying a fluorescent penetrant solution to a metallic article, optionally applying a developer solution to the metallic article, exposing the metallic article to UV light, and identifying fluorescing aggregate lodged in a feature of the metallic article.

This summary is provided to introduce a selection of concepts that are further described below in the detailed description. This summary is not intended to identify key or essential features of the claimed subject matter, nor is it intended to be used as an aid in limiting the scope of claimed subject matter.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIG. 1 illustrates a partial hidden view of an exemplary isotropic superfinish system for applying an isotropic superfinish to a metallic article according to aspects of the disclosure;

FIG. 2 illustrates a partial hidden view of the isotropic superfinish system of FIG. 1 with a metallic article placed therein for treatment according to aspects of the disclosure;

FIG. 3 illustrates a metallic article according to aspects of the disclosure;

FIG. 4 is a flow chart illustrating a method of identifying aggregate that has become lodged in features of a metallic article according to aspects of the disclosure;

FIG. 5 illustrates a system for removing aggregate that has become lodged in features of a metallic article according to aspects of the disclosure; and

FIG. 6 is a flow chart illustrating a method of removing aggregate that has become lodged in features of a metallic article according to aspects of the disclosure.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

Surfaces of metallic articles, such as components of machinery, are often treated to help prevent wear, cracks, and other defects. Traditional surface treatments often include abrasive techniques such as machining or grinding that result in machining lines or swirls being formed on a surface that is treated. There are a variety of metallic articles that include critical working surfaces for which the machining lines/swirls can be problematic. For example, some metallic articles that include critical working surfaces include portions of splines, crankshafts, camshafts, bearings, gears, couplings, and journals. For these metallic articles, machining lines or swirls formed on the critical working surfaces can cause poor surface contact performance due to, for example, increased friction, torque, noise, vibration, and operating temperature. The machining line/swirls can also result in impaired lubricity and failure from wear, scuffing, plastic deformation, contact fatigue, and bending fatigue. For gears or other parts placed in a demanding environment such as the drivetrain of machines, vehicles, and the like, resistance to these types of failures and defects can, in effect, define the useful life of the metallic article.

Critical working surfaces (including recessed areas) have conventionally been refined through various machine grinding/polishing processes. But those processes can have multiple drawbacks. For complex shapes (e.g., gear teeth, adjacent features, and the like), machine grinding tools are very expensive, require skilled operators, and undergo excessive wear, and may have machinability issues. Furthermore, machining and grinding are typically carried out on a part-by-part basis and feature-by-feature basis, as such, are plagued with problems of repeatability and uniformity.

In order improve the surface finish or appearance created by traditional machining and grinding processes, alternative surface treatments are available. One such treatment is known as an isotropic superfinish (ISF) process. The isotropic superfinish process refines surfaces of metallic articles for mechanical improvement and/or cosmetic purposes so that the surface of those articles is isotropic and finished to a high polish. Treating metallic articles with the ISF process results in surfaces having improved wear characteristics compared to machining and grinding processes and that are also less susceptible to crack formation and propagation. The ISF process is a chemically accelerated vibratory mass finishing process that uses vibration in combination with a special media to produce a polished/finished surface.

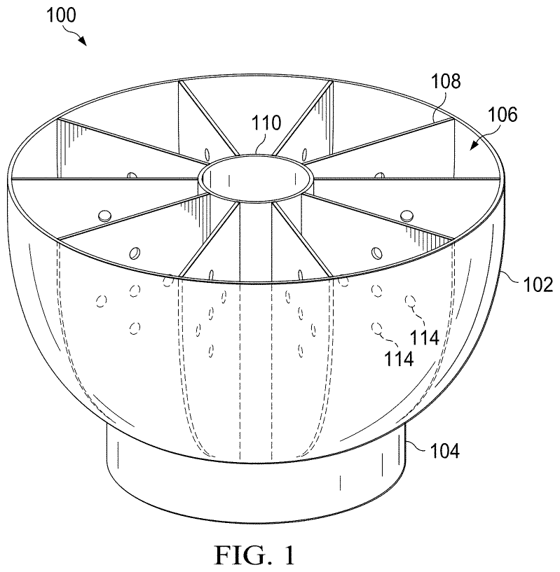

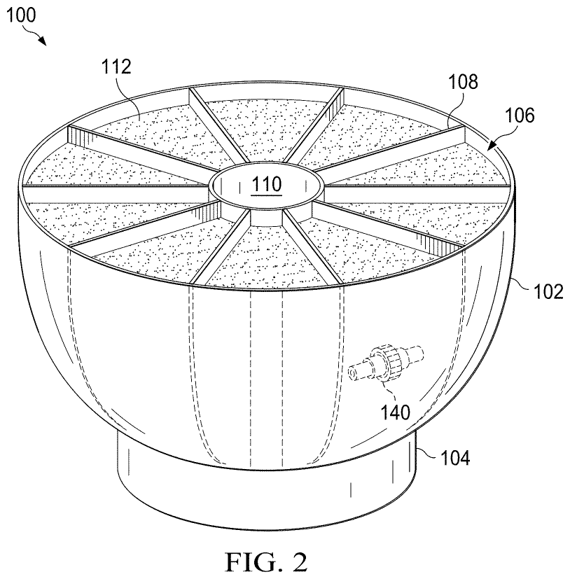

FIGS. 1 and 2 illustrate an isotropic superfinish system 100 for applying an isotropic superfinish to a metallic article 140. In some isotropic superfinish processes, metallic articles are placed into a bowl 102 for processing. FIG. 1 illustrates the isotropic superfinish system 100 in partial hidden view to show some of the structure within the bowl 102. FIG. 2 illustrates the isotropic superfinish system 100 in partial hidden view to show metallic article 140 positioned within bowl 102 for treatment. Bowl 102 sits on a base 104. Metallic article can be any of a wide variety of metallic parts upon which a smooth finish is desired. In various embodiments, metallic article 140 may comprise one or more of a gear, spline, crankshaft, camshaft, bearing, bearing surface, coupling, shaft, journal, a tool (e.g., a wrench), and the like. Dimensions and form of metallic article 140 may vary.

An interior of bowl 102 may be divided into a plurality of pockets 106 by a plurality of baffles 108 that are spaced equally about bowl 102. As shown in FIGS. 1 and 2, the plurality of pockets 106 are wedge shaped. In other embodiments, more or fewer baffles 108 may be used to form more or fewer pockets 106. In some embodiments, one or more baffles 108 may be removed to create pockets 106 of different sizes. The plurality of baffles 108 help separate multiple metallic articles 140 from each other so that multiple metallic articles 140 may be placed into the bowl 102 for treatment without touching one another.

An aggregate 112 is positioned within pockets 106 of bowl 102. Aggregate 112 is typically comprised of multiple components and may include a chemical solution that softens a surface of metallic article 140. For example, aggregate 112 may comprise one or more ceramic media and/or optionally one or more plastic media. Aggregate 112 may include media of a wide variety of sizes and shapes. For example, aggregate 112 can include one or more of the following: angle-cut cylinders; pieces that are round, rectangular, triangular, or other polygonal shapes; and pieces that are indefinite or that have random shapes and sizes. In some aspects, the smallest dimension of the media may be about 0.5 mm and the largest dimension may be about 13 mm. The size and configuration of the elements that will be most suitable for a particular application will depend upon parameters of the metallic articles being process (e.g., the weight, dimensions, and configurations of the metallic articles), which will also indicate an optimal ratio of parts-to-media, as will be evident to those skilled in the art.

During operation of isotropic superfinish system 100, aggregate 112 rotates slowly about a central portion 110 of the bowl 102 due to the vibratory forces imposed on the aggregate 112. As the aggregate 112 moves around the bowl 102, metallic article 140 moves with the aggregate 112 and is stirred around the bowl 102. This stirring action helps expose metallic article 140 to the chemical solution and aggregate 112. Over time, metallic article 140 is polished by isotropic superfinish system 100.

In some aspects, base 104 and/or central portion 110 may include components configured to provide vibratory forces to bowl 102 and contents of bowl 102. In an exemplary embodiment, aggregate 112, along with the plurality of baffles 108, rotates in a counter-clockwise direction. In other embodiments, the aggregate 112 and the plurality of baffles 108 may rotate in a clockwise direction. Each baffle 108 includes a plurality of holes 114 through which some of aggregate 112 may pass as the plurality of baffles 108 rotate about the bowl 102. To allow aggregate 112 to pass through the plurality of holes 114 without clogging the plurality of holes 114, each hole 114 has a diameter that is several times larger than a dimeter of the largest component of the aggregate 112. The stirring action of aggregate 112 and the plurality of baffles 108 helps to cause the metallic article 140 to move about within the aggregate 112 to cause surfaces of the metallic article 140 to come into contact with the aggregate 112 so that the surfaces of the metallic article 140 receive an isotropic superfinish.

The ISF process is typically carried out by placing metallic article 140 into bowl 102 that is filled with aggregate 112 and a chemical solution. In an exemplary embodiment, the chemical solution is supplied periodically to bowl 102 during application of a vibratory force. The chemical solution may be sprayed into bowl 102 by one or more sprayers that are positioned proximate bowl 102. For example, the one or more sprayers may be secured to central portion 110. The chemical solution is chosen to be mildly reactive with the metallic article 140. When the chemical solution comes into contact with the metallic article 140 it forms a reaction product on exposed surfaces of metallic article 140. Over time, the vibration of aggregate 112 against the metallic article 140 removes the reaction product and polishes the surface to create an isotropic superfinish.

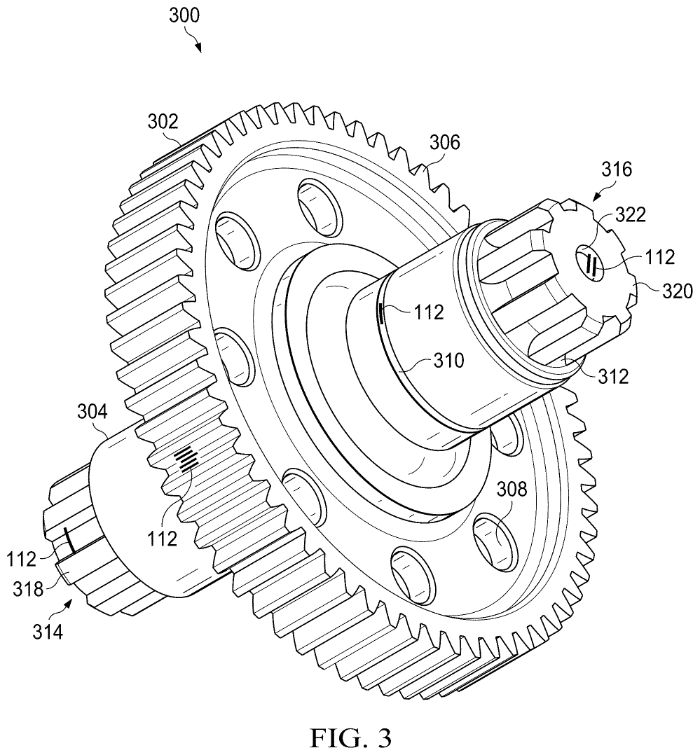

The above isotropic superfinish process can be used to apply surface treatments to a wide range of metallic articles. In practice, it has been found that bits of aggregate 112 become lodged into features of the metallic articles (e.g., holes, gear teeth, grooves, and the like) during processing. FIG. 3 is an isometric view of an illustrative metallic article 300. Metallic article 300 is used only for illustrative purposes. It should be understood that the description of metallic article 300 applies to other metallic articles comprising other shapes and is not limited to the specific shape of metallic article 300. Metallic article 300 includes a gear 302 disposed on a shaft 304. Gear 302 includes various features such as teeth 306 and holes 308. Shaft 304 includes various features such as a groove 310, a groove 312, a first end 314, and a second end 316. Each of ends 314, 316 comprise teeth 318, 320, respectively. End 316 additionally includes a hole 322. In practice, it has been observed that aggregate 112 sometimes becomes lodged in the various features (e.g., features 306, 308, 310, 312, 318, 320, and 322) of metallic article 300. For illustrative purposes, aggregate 112 is shown loaded in teeth 306, 318, groove 310, and hole 322. While a single piece of aggregate 112 is shown lodged in teeth 318 and groove 310 and multiple pieces of aggregate 112 are shown lodged in teeth 306 and hole 322, it should be appreciated that aggregate 112 can become lodged in the features of metallic article 300 in a great many different combinations. Lodged aggregate 112 of FIG. 3 is shown merely for illustrative purposes. In practice, it has been found that aggregate 112 can become lodged into features with openings ranging between about 0.025 inches to about 1.037 inches. Metallic article 300 is used as an illustrative embodiment. A wide of metallic articles treated with the ISF process are susceptible to the problem of aggregate 112 becoming lodged in features of the treated metallic articles.

Aggregate 112 that becomes lodged into features of metallic articles 300 must be removed before using metallic articles 300. Failure to remove aggregate 112 can lead to catastrophic failures of metallic articles 300 and/or the machines/devices in which metallic articles 300 are used. Various difficulties arise regarding removal of aggregate 112 that has become lodged in features of metallic articles 300. A first difficulty is identifying all aggregate 112 that has become lodged and a second difficulty is removing the lodged aggregate 112 that has become lodged.

Identifying all of the lodged aggregate 112 can be difficult for various reasons. In some instances, the lodged aggregate 112 may be similar in color to metallic article 300. The similarity in color makes it difficult for a person inspecting metallic article 300 to easily recognize the presence of lodged aggregate 112. Identifying all of the lodged aggregate 112 can also be difficult because some of the features of metallic article 300 may be difficult to see because of obstructions or because some of the features are recessed. Removing the identified lodged aggregate 112 can be difficult because the lodged aggregate 112 can become very tightly packed/lodged into the features of metallic article 300. In order to remove tightly lodged aggregate 112, a significant amount of force can be necessary. Applying the amount of force that is sometimes needed to remove the lodged aggregate 112 using a tool, such as an o-ring pick or the like, to pick or pry out the lodged aggregate 112 risks damaging the finish of metallic article 300. Other removal methods such as spraying compressed air or solvent has proven to be insufficient to remove all lodged aggregate 112. This disclosure describes improvements to both of the two difficulties discussed above.

### Identifying Lodged Aggregate

Conventionally, performing a visual inspection of metallic article 300 is the primary method used to identify the presence of lodged aggregate 112. Visual inspection has proven to be an unreliable method for consistently identifying all lodged aggregate 112. As noted above, aggregate 112 is often a very similar color to metallic article 300. Aggregate 112 can also become lodged in features that are difficult to see because of the location of the feature. For example, the feature may be recessed or blocked from view. To improve the identification of lodged aggregate 112, metallic article 300 can be inspected using a fluorescent penetrant inspection process. Fluorescent penetrant inspection processes are conventionally used to identify cracks in metallic parts. It has been determined that this process is also helpful in identifying lodged aggregate 112.

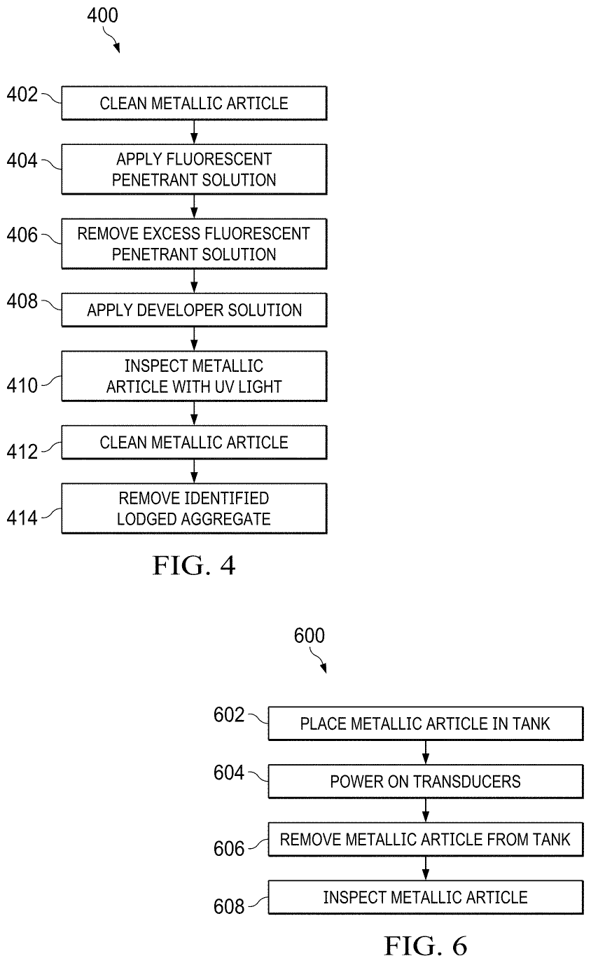

FIG. 4 is a flow chart of an illustrative process 400 for identifying aggregate 112 that has become lodged in a feature of metallic article 300. Process 400 begins at step 402. In step 402, metallic article 300 is cleaned. Cleaning metallic article 300 removes any remnants of chemicals/contaminants and the like from metallic article 300 that may reside on an exterior surface of metallic article 300 as a result of applying the ISF treatment. Removing contaminants is important because the contaminants may interact with the fluorescent penetrant solution that is applied later on in process 400. Cleaning may be done by rinsing or spraying metallic article 300 with a cleaning solution or by placing metallic article 300 into a bath of cleaning solution. The cleaning solution may be a solvent, aqueous, or vapour degreasing method. After cleaning metallic article 300, process 400 proceeds to step 404.

At step 404, the fluorescent penetrant solution is applied to metallic article 300. The fluorescent penetrant solution is applied to metallic article 300 by submerging metallic article 300 in a bath of the fluorescent penetrant solution. The amount of time metallic article 300 is submerged in the fluorescent penetrant solution varies. In some aspects, metallic article 300 is submerged for less than one minute. In some aspects, metallic article 300 is submerged for between about 1 minute and 30 minutes. After the fluorescent penetrant solution has been applied to metallic article 300, process 400 proceeds to step 406.

At step 406, excess fluorescent penetrant solution is removed from metallic article 300. In some aspects, excess fluorescent penetrant solution is removed by wiping metallic article 300 with a lint free cloth. After excess fluorescent penetrant solution has been removed, process 400 proceeds to step 408.

At step 408, a developer solution is optionally applied to metallic article 300. In some aspects, a developer solution is not needed. Applying the developer solution acts as contrast to help the fluorescent penetrant solution stand out in step 410. In some aspects, the developer solution also causes the fluorescent penetrant solution to bleed and spread out a bit to make it easier to locate. After developer solution has been applied, process 400 proceeds to step 410.

At step 410, metallic article 300 is placed into a dark chamber and exposed to ultraviolet (UV) light. The ultraviolet light causes the fluorescent penetrant solution to fluoresce and glow. In practice, it has been observed that lodged aggregate 112 tends to retain some fluorescent penetrant solution. The retained fluorescent penetrant solution fluoresces under the UV light, allowing for much easier visual identification of lodge aggregate 112. Process 400 then proceeds to step 412. At step 412, metallic article 300 is cleaned to remove the fluorescent penetrant solution and developer solution. Process 400 then proceeds to step 414. At step 414, the lodged aggregate 112 identified in step 410 is removed. In some aspects, aggregate 112 is removed using hand tools (e.g., o-ring pick or the like). In some aspects, aggregate 112 is removed using a cleaning process that uses ultrasonic energy (discussed in more detail below). Process 400 then ends.

It should be appreciated that one or more steps of process 400 can be modified or omitted in some aspects. For example, one or more of steps 404, 408, and 410 may be modified or removed altogether.

### Removing Lodged Aggregate

Conventionally, lodged aggregate 112 has been removed using hand tools and/or compressed air. Hand tools are capable of removing some of the lodged aggregate 112. However, in practice removing all of the lodged aggregate 112 with hand tools can be very difficult. For example, sometimes the lodged aggregate 112 is so tightly lodged between opposed surfaces of metallic article 300 that the force required to remove the lodged aggregate 112 is too great. In some aspects, using hand tools to remove the lodged aggregate 112 would damage the ISF surface treatment. In some aspects, the lodged aggregate 112 may be in a location that is not easily accessed by hand tools. Compressed air can sometimes be used to remove some of the lodged aggregate 112. However, in most instances the compressed air cannot supply the force required to remove the lodged aggregate 112. As an alternative to using hand tools and compressed air, it has been determined that an ultrasonic cleaning process can be used.

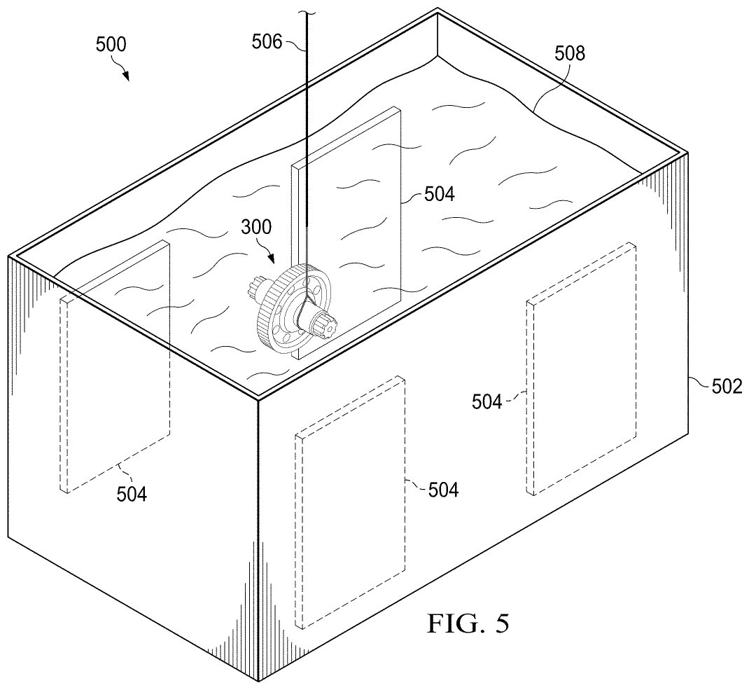

Ultrasonic cleaning utilizes high-frequency sound waves to energize a liquid. FIG. 5 illustrates a system 500 for processing metallic article 300 with ultrasonic cleaning. System 500 includes a tank 502 into which metallic article 300 is placed. FIG. 5 is shown in partial hidden view to more clearly illustrate the placement of metallic article 300 within tank 502. System 500 further includes a plurality of transducers 504 positioned within tank 502. In FIG. 5, the plurality of transducers 504 are positioned within tank 502 as opposing pairs. In other aspects, other arrangements of the plurality of transducers 504 may be used. In some aspects, a single transducer 504 may be used. Each transducer 504 is coupled to a power source that provides each transducer 504 with energy to generate high-frequency sound waves. In some aspects, the plurality of transducers 504 generate sound waves between about 20-132 kHz. The plurality of transducers 504 may generate sound waves at a single frequency or at multiple frequencies simultaneously. In some aspects, the plurality of transducers 504 generate sound waves that sweep through a range of frequencies. For example, the plurality of transducers 504 may generate sound waves that sweep from about 20 kHz to 132 kHz. In some aspects, the plurality of transducers 504 generate sound waves having frequencies generally in the range of the natural frequency of one or more pieces of the lodged aggregate 112 or metallic article 300. In some aspects, the plurality of transducers 504 generate sound waves having frequencies generally in the range of one or more harmonic frequencies of one or more pieces of the lodged aggregate 112 or metallic article 300. Generally in the range of one or more harmonic frequencies or the natural frequency is used herein to mean within about 1%, 2%, 3%, 5%, or 10% of the one or more harmonic frequencies or the natural frequency of the lodged aggregate 112 or metallic article 300. Generating sound waves generally in the range of the natural frequency or harmonic frequency of the lodged aggregate 112 or metallic article 300 can excite the lodged aggregate 112 or metallic article 300 to dislodge the lodged aggregate 112 from features of metallic article 300.

Metallic article 300 is shown hanging from a line 506 and submerged in a liquid 508. Line 506 can be secured to metallic article 300 in a variety of ways. In some aspects, line 506 can include a hook or a clamp that couples to metallic article 300. In other aspects, line 506 may be tied to metallic article 300. In other aspects, metallic article 300 can rest on a stand or support that is located within tank 502. Liquid 508 can comprise water, a solvent, oil, or alkaline solution. Liquid 508 is energized by the sound waves generated by the plurality of transducers 504. A sound wave is a wave of compression and rarefaction, by which sound is propagated in a medium (e.g., a fluid such as a liquid or gas). The sound waves generated by the plurality of transducers 504 create compression waves in liquid 508. The compression waves shear liquid 508, creating tiny voids. The formation and subsequent closing of the voids creates a cavitation effect. This cavitation effect generates a tremendous amount of energy in the form of both temperature and heat that is transmitted into metallic article 300 and the lodged aggregate 112. This energy works the lodged aggregate 112 free from metallic article 300. In this way, lodged aggregate 112 can be removed much more efficiently and easily compared to using hand tools or compressed air. This method is also beneficial as the method removes the lodged aggregate 112 regardless of whether or not the lodged aggregate 112 was previously identified by visual inspection.

In some aspects, metallic article 300 may be heated prior treatment in tank 502. Heating metallic article 300 can help remove lodged aggregate 112 because the metal of metallic article 300 has a different coefficient of thermal expansion than lodged aggregate 112.

FIG. 6 is a flowchart of an illustrative process 600 for removing lodged aggregate 112 from metallic article 300. Process 600 begins at step 602. In step 602, metallic article 300 is lowered into tank 502. In some aspects, metallic article 300 is secured to line 506 and lowered into liquid 508. In some aspects, metallic article is lowered into liquid 508 onto a stand or support located within tank 502. After metallic article 300 has been submerged in liquid 508, process 600 proceeds to step 604.

In step 604, the plurality of transducers 504 are powered to begin generating sound waves. The frequency of the sound waves can vary based upon a particular application. In some aspects, the sound waves are between about 20 kHz and 40 kHz. In some aspects, the sound waves are between about 20 kHz and 138 kHz. In some aspects, the plurality of transducers 504 generate sound waves at a single frequency or at multiple frequencies simultaneously. In some aspects, the plurality of transducers 504 generate sound waves that sweep through a range of frequencies. For example, the plurality of transducers 504 may generate sound waves that sweep from 20 kHz to 40 kHz. In some aspects, the plurality of transducers 504 generate sound waves having frequencies generally in the range of the natural frequency of one or more pieces of the lodged aggregate 112 or of metallic article 300. In some aspects, the plurality of transducers 504 generate sound waves having frequencies generally in the range of one or more harmonic frequencies of one or more pieces of the lodged aggregate 112 or metallic article 300. The time of sound wave exposure of metallic article 300 can vary. In some aspects, metallic article 300 is exposed to sound waves for about five to about ten minutes. In other aspects, metallic article 300 is exposed to sound waves for less than five minutes or more than ten minutes. After treatment, process 600 proceeds to step 606.

In step 606, metallic article 300 is removed from tank 502. Process 600 then proceeds to step 608. In step 608, metallic article 300 is inspected to determine if all of the lodged aggregate 112 has been removed. If all of the lodged aggregate 112 has been removed, process 600 ends. If any of the lodged aggregate 112 remains, process 600 can return to step 604 for additional treatment or proceed to step 608. In step 608, hand tools and/or compressed air can be used to remove any remaining lodged aggregate 112. Once all of the lodged aggregate 112 has been removed, either from additional treatment or by manually removing the lodged aggregate 112, process 600 ends.

The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” “generally,” “generally in the range of,” and “about” may be substituted with “within [a percentage] of” what is specified, as understood by a person of ordinary skill in the art. For example, within 1%, 2%, 3%, 5%, and 10% of what is specified herein.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. An aggregate-removal method comprising:
placing a metallic article in a tank of fluid, a piece of aggregate being lodged in a feature of the metallic article; and
treating the metallic article with sound waves to dislodge the lodged aggregate from the metallic article.

2. The method of claim 1, wherein the sound waves comprise a frequency between about 20-138 kHz.

3. The method of claim 1, wherein the treating the metallic article with sound waves comprises generating ultrasonic sound waves with a transducer.

4. The method of claim 3, wherein the generating ultrasonic sound waves with the transducer comprises generating a single frequency of ultrasonic sound waves.

5. The method of claim 3, wherein the generating ultrasonic sound waves with the transducer comprises generating a sweep of sound waves from about 20 kHz to about 138 kHz.

6. The method of claim 3, wherein the generating ultrasonic sound waves with the transducer comprises generating multiple frequencies simultaneously.

7. The method of claim 1, wherein the treating the metallic article with sound waves comprises generating sound waves with a frequency generally in the range of the natural frequency of the metallic article.

8. The method of claim 1, wherein the treating the metallic article with sound waves comprises generating sound waves with a frequency generally in the range of a harmonic frequency of the metallic article.

9. The method of claim 1, wherein the treating the metallic article with sound waves comprises generating sound waves with a frequency generally in the range of the natural frequency of the piece of aggregate.

10. The method of claim 1, wherein the treating the metallic article with sound waves comprises generating sound waves with a frequency generally in the range of a harmonic frequency of the piece of aggregate.

11. The method of claim 1, wherein the fluid comprises a solvent.

12. The method of claim 1, wherein the fluid comprises water.

13. The method of claim 1, wherein the metallic article is heated prior to the placing the metallic article in the tank of fluid.

14. The method of claim 1, comprising:
removing the metallic article from the tank of fluid;
inspecting the metallic article to determine if the piece of aggregate has been removed by the treating; and
responsive to a determination that the piece of aggregate has not been removed by the treating, repeating the treating step.

15. The method of claim 14, wherein the repeating the treating step comprises treating the metallic article with sound waves having a different frequency than the original treating step.

16. An aggregate identification method comprising:
applying a fluorescent penetrant solution to a metallic article;
exposing the metallic article to UV light; and
identifying fluorescing aggregate lodged in a feature of the metallic article.

17. The method of claim 16, comprising cleaning the metallic article prior to the applying the fluorescent penetrant solution.

18. The method of claim 16, comprising removing excess fluorescent penetrant solution from the metallic article and applying a developer solution.

19. The method of claim 18, comprising removing the developer solution and the penetrant fluorescent solution after the identifying.

20. The method of claim 16, comprising treating the metallic article with an ultrasonic cleaning process after the identifying.
